(19) United States
(12) Patent Application Publication
(10) Pub. No.: US 2014/0118415 A1
(43) Pub. Date: May 1, 2014

(54) ORGANIC LIGHT-EMITTING DIODE (OLED) DISPLAY, METHOD OF AUTHENTICATING THE DISPLAY, AND IDENTIFICATION CARD COMPRISING THE DISPLAY

(71) Applicant: SAMSUNG DISPLAY CO., LTD., Yongin-city (KR)

(72) Inventor: Hae Kwan Seo, Hwaseong-si (KR)

(73) Assignee: Samsung Display Co., Ltd., Yongin-city (KR)

(21) Appl. No.: 13/837,505

(22) Filed: Mar. 15, 2013

(30) Foreign Application Priority Data
Oct. 25, 2012 (KR) 10-2012-0119207

(51) Int. Cl. G09G 3/32

(52) U.S. Cl. CPC G09G 3/3208
USPC 345/690; 345/82

(57) ABSTRACT

An organic light-emitting diode (OLED) display is disclosed. In one aspect, the display includes a plurality of pixels. At least two of the pixels are configured such that a value, into which a permutation or combination of luminance values of light emitted respectively from the at least two or more pixels is converted based on data of an original image displayed on the display, is used as identification information for identifying the display.

This application claims priority from Korean Patent Application No. 10-2012-0119207 filed on Oct. 25, 2012 in the Korean Intellectual Property Office, the disclosure of which is incorporated herein by reference in its entirety.

### BACKGROUND

1. Field

The described technology generally relates to an organic light-emitting diode (OLED) display, a method of authenticating the display, and an identification card including the display.

2. Description of the Related Technology

The development of information and communications technology and the diverse needs of the information society are increasing the demands for display devices. Most cathode ray tube (CRT) displays have been replaced with flat panel displays (FPDs) to meet the demands of compactness and reduced power consumption. Some of the most widely used FPDs include electroluminescent displays (ELDs), liquid crystal displays (LCDs), organic light-emitting diode (OLED) displays, and plasma display panels (PDPs).

OLEDs emit light by electrically exciting an organic compound. OLEDs can be driven at a low voltage and have a wide viewing angle and a short response time. Due to these advantages, OLEDs are used in an increasingly wide range of applications.

An OLED generally includes an anode electrode, a cathode electrode, and a light-emitting layer interposed between the anode electrode and the cathode electrode. In the light-emitting layer, holes supplied from the anode electrode and electrons supplied from the cathode electrode may combine to form excitons. The light-emitting layer may emit light due to energy generated when the excitons return to a ground state.

OLEDs are generally classified into either top emission OLEDs or bottom emission OLEDs according to the position of a surface from which light is emitted.

### SUMMARY

One inventive aspect is an organic light-emitting diode (OLED) display including identification information.

Another aspect is a method of authenticating an OLED display.

Another aspect is an OLED display which can prevent the forging or falsification of identification information, a method of authenticating the OLED display, and an identification card including the OLED display.

Another aspect is an organic light-emitting diode (OLED) display comprising a plurality of pixels, wherein at least two or more of the pixels are formed such that a value, into which a permutation or combination of luminance values of light emitted respectively from the at least two or more pixels is converted based on data of an original image displayed on the OLED display, is used as identification information for identifying the OLED display.

Each of the pixels may comprise a thin-film transistor (TFT), a first electrode disposed on the TFT, and an organic layer disposed on the first electrode, and further comprising a second electrode disposed on the pixels, wherein at least two or more of portions of the second electrode which overlap the pixels have different thickness values.

Each of the pixels may further comprise a pixel defining film, wherein the pixel defining film is disposed on the TFT and does not cover the first electrode or covers part of the first electrode, and the second electrode is disposed on the pixel defining film and the pixels.

Each of the pixels may comprise a TFT, a first electrode disposed on the TFT, an organic layer disposed on the first electrode, and a second electrode disposed on the organic layer, wherein the second electrodes included in at least two or more of the pixels have different thickness values.

A type of the identification information may be a barcode or a quick response (QR) code.

Another aspect is an organic light-emitting diode (OLED) display comprising a first region comprising at least one pixel; and a second region comprising at least one pixel which emits light having a lower luminance than that of light emitted from the at least one pixel of the first region, wherein the first region and the second region are formed such that a value, into which luminance values of light emitted from the first region and the second region are converted based on data of an original image displayed on the OLED display and regardless of a type of the original image, is used as identification information for identifying the OLED display.

Each of the at least one pixel included in the first region and the at least one pixel included in the second region may comprise a TFT, a first electrode disposed on the TFT, an organic layer disposed on the first electrode, and a second electrode disposed on the organic layer, wherein a thickness of the second electrode included in the at least one pixel of the first region is different from a thickness of the second electrode included in the at least one pixel of the second region.

Another aspect is an organic light-emitting diode (OLED) display comprising a plurality of pixels, wherein each of the pixels comprises a TFT, a first electrode disposed on the TFT, an organic layer disposed on the first electrode; and a second electrode disposed on the organic layer, wherein the second electrodes included in at least two or more of the pixels are disposed such that a permutation or combination of thickness values of the second electrodes included in the at least two or more pixels is used as identification information for identifying the OLED display.

Another aspect is an organic light-emitting diode (OLED) display comprising a plurality of pixels, wherein each of the pixels comprises a TFT, a first electrode disposed on the TFT, a hole injecting layer disposed on the first electrode, a hole transporting layer disposed on the hole injecting layer, a light-emitting layer disposed on the hole transporting layer, an electron transporting layer disposed on the light-emitting layer, and a second electrode disposed on the electron transporting layer, wherein the light-emitting layers included in at least two or more of the pixels are disposed such that a permutation or combination of thickness values of the light-emitting layers included in the at least two or more pixels is used as identification information for identifying the OLED display.

Another aspect is an organic light-emitting diode (OLED) display comprising a plurality of pixels, wherein at least two or more of the pixels are formed such that a value, into which a permutation or combination of chromaticity values of light emitted respectively from the at least two or more pixels is converted based on data of an original image displayed on the OLED display, is used as identification information for identifying the OLED display.

Another aspect is a method of authenticating an organic light-emitting diode (OLED) display, the method comprising displaying an original image on the OLED display which comprises a plurality of pixels, scanning the OLED display, which is displaying the original image using a scanner, reading identification information for identifying the OLED display by comparing the scanned image and the original image, and authenticating the OLED display using the read identification information.

In the reading of the identification information, the identification information may be read based on a permutation or combination of luminance values of light emitted respectively from at least two or more of the pixels.

In the reading of the identification information, the identification information may be read based on a permutation or combination of chromaticity values of light emitted respectively from at least two or more of the pixels.

Another aspect is an identification card comprising an organic light-emitting diode (OLED) display which comprises a plurality of pixels, wherein at least two or more of the pixels are formed such that a value, into which a permutation or combination of luminance values of light emitted respectively from the at least two or more pixels is converted based on data of an original image displayed on the OLED display, is used as identification information for identifying the OLED display.

Each of the pixels may comprise a TFT, a first electrode disposed on the TFT, and an organic layer disposed on the first electrode, and the OLED display further comprises a second electrode disposed on the pixels, wherein at least two or more of portions of the second electrode which overlap the pixels have different thickness values.

Each of the pixels may further comprise a pixel defining film, wherein the pixel defining film is disposed on the TFT and does not cover the first electrode or covers part of the first electrode, and the second electrode is disposed on the pixel defining film and the pixels.

Each of the pixels may comprise a TFT, a first electrode disposed on the TFT, an organic layer disposed on the first electrode, and a second electrode disposed on the organic layer, wherein the second electrodes included in at least two or more of the pixels have different thickness values.

### BRIEF DESCRIPTION OF THE DRAWINGS

FIG. 1 is a longitudinal sectional view of an organic light-emitting diode (OLED) display according to a first embodiment.

FIG. 2 is a diagram showing, side by side, an original image and a scanned image of the original image displayed on the OLED display according to the first embodiment.

FIG. 3 is a longitudinal sectional view of an OLED display according to a second embodiment.

FIG. 4 is a longitudinal sectional view of an OLED display according to a third embodiment.

FIG. 5 is an enlarged longitudinal sectional view of the OLED display according to the third embodiment.

FIG. 6 is a flowchart illustrating a process of authenticating an OLED display according to an embodiment.

### DETAILED DESCRIPTION

Embodiments will be described with reference to the accompanying drawings. Like numbers refer to like elements throughout. In the drawings, the thickness of layers and regions may be exaggerated for clarity.

It will be understood that when an element or layer is referred to as being “on,” or “connected to” another element or layer, it can be directly on or connected to the other element or layer or intervening elements or layers may be present. In contrast, when an element is referred to as being “directly on” or “directly connected to” another element or layer, there are no intervening elements or layers present. As used herein, the term “and/or” includes any and all combinations of one or more of the associated listed items.

Spatially relative terms, such as “below,” “beneath,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

Embodiments described herein will be described referring to plan views and/or cross-sectional views by way of ideal schematic views of embodiments. Accordingly, the exemplary views may be modified depending on manufacturing technologies and/or tolerances. Therefore, the invention is not limited to those shown in the views, but include modifications in configuration formed on the basis of manufacturing processes. Therefore, regions exemplified in figures have schematic properties and shapes of regions shown in figures exemplify specific shapes of regions of elements and not limit aspects of the invention.

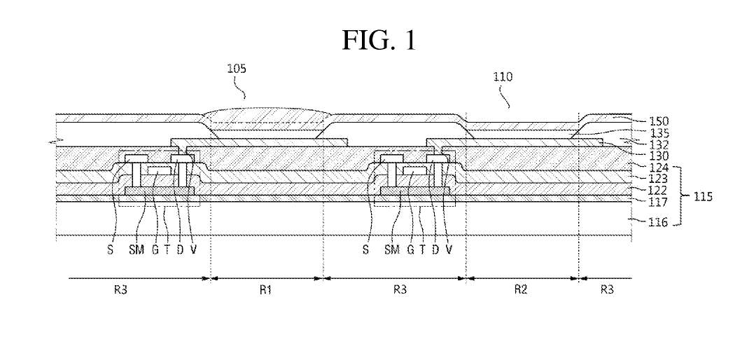

FIG. 1 is a longitudinal sectional view of an OLED display according to a first embodiment.

Referring to FIG. 1, the OLED display may include a plurality of pixels 105 and 110. The pixels 105 and 110 may be minimum units that constitute a screen image displayed on the OLED display. The pixels 105 and 110 may be arranged two-dimensionally in the OLED display.

Each of the pixels 105 and 110 may include a thin-film transistor (TFT) substrate 115, a first electrode 130 disposed on the TFT substrate 115, an organic layer 135 disposed on the first electrode 130, and a second electrode 150 disposed on the organic layer 135. Each of the pixels 105 and 110 may further include a pixel defining film 132. The pixel defining film 132 may be disposed on the TFT substrate 115 and may not cover the first electrode 130 or may cover part of the first electrode 130.

The TFT substrate 115 may be connected to a driver (not shown) of the OLED display. The TFT substrate 115 may be controlled by the driver to apply a voltage to the first electrode 130, thereby controlling each of the pixels 105 and 110 to emit or not emit light.

Referring to FIG. 1, the TFT substrate 115 may include a base substrate 116, a buffer layer 117, a semiconductor layer SM, a gate electrode Q a source electrode S, a drain electrode D, a gate insulating film 122, an interlayer insulating film 123, and a planarization film 124.

The base substrate 116 may be made of a transparent insulating material. For example, the base substrate 116 may be made of glass, quartz, ceramic, plastic, or the like. The base substrate 116 may be flat. The base substrate 116 may be made of a material that is not easily bent by an external force or a material that is easily bent by an external force. The base substrate 116 may support other components disposed thereon.

The buffer layer 117 may be disposed on the base substrate 116. The buffer layer 117 can prevent the penetration of impurities. The buffer layer 117 may planarize a top surface of the base substrate 116. The buffer layer 117 may be made of various types of materials. For example, the buffer layer 117 may be made of a silicon nitride (SiNₓ) film, a silicon oxide (SiO₂) film, a silicon oxynitride (SiOₓN_{y}) film, or a combination of the same. Depending on the embodiment, the buffer layer 117 can be omitted.

The semiconductor layer SM may be disposed on the buffer layer 117. The semiconductor layer SM may be made of an amorphous silicon film or a polycrystalline silicon film. The semiconductor layer SM may include a channel region which is undoped with impurities and a source region and a drain region which are disposed on both sides of the channel region and are p+-doped to contact the source electrode S and the drain electrode D, respectively. Here, impurities used to dope the semiconductor layer SM may be boron (B)-containing P-type impurities such as B₂H₆. The type of impurities used to dope the semiconductor layer SM may vary according to the embodiment.

The gate insulating film 122 may be disposed on the semiconductor layer SM. The gate insulating film 122 may insulate the gate electrode G from the semiconductor layer SM. The gate insulating film 122 may be made of SiNₓ or SiO₂.

The gate electrode G may be disposed on the gate insulating film 122. The gate electrode G may overlap at least part of the semiconductor layer SM. A voltage applied to the gate electrode G may control the semiconductor layer SM to become conductive or non-conductive.

For example, when a voltage higher than a predetermined voltage is applied to the gate electrode G, the semiconductor layer SM may have conductivity. In addition, when a voltage lower than the predetermined voltage is applied to the gate electrode G, the semiconductor layer SM may not have conductivity. When the semiconductor layer SM has conductivity, the drain electrode D and the source electrode S may be electrically connected to each other. When the semiconductor layer SM does not have conductivity, the drain electrode D and the source electrode S may be insulated from each other.

The interlayer insulating film 123 may be disposed on the gate electrode G The interlayer insulating film 123 may cover the gate electrode G The interlayer insulating film 123 may insulate the gate electrode G and the source electrode S from each other. In addition, the interlayer insulating film 123 may insulate the gate electrode G and the drain electrode D from each other. The interlayer insulating film 123 may be made of SiNₓ or SiO₂.

The source electrode S and the drain electrode D may be disposed on the interlayer insulating film 123. The source electrode S and the drain electrode D may be connected to the semiconductor layer SM by through holes which pass through the interlayer insulating film 123 and the gate insulating film 122, respectively.

The source electrode S, the drain electrode D, the gate electrode G, and the semiconductor layer SM may form a TFT T. The TFT T may deliver a signal, which is transmitted to the source electrode S, to the drain electrode D according to a voltage applied to the gate electrode G.

The planarization film 124 may be disposed on the interlayer insulating film 123, the source electrode S and the drain electrode D. The planarization film 124 may remove a step difference between a top surface of the source electrode S and a top surface of the drain electrode D. Accordingly, this can increase light-emission efficiency of the organic layer 135 disposed on the planarization film 124.

The planarization film 124 may be made of polyacrylates resin, epoxy resin, phenolic resin, polyamides resin, polyimides resin, unsaturated polyesters resin, poly phenylenethers resin, poly phenylenesulfides resin, benzocyclobutene (BCB), or a combination of the same.

A via hole V may be formed in the planarization film 124. The first electrode 130 may be electrically connected to the drain electrode D by the via hole V.

The first electrode 130 may be disposed on the TFT substrate 115. The first electrode 130 may be electrically connected to the drain electrode D of the TFT substrate 115 by the via hole V. The first electrode 130 may deliver a signal, which is transmitted to the drain electrode D, to the organic layer 135.

The first electrode 130 may be made of a conductive material. The first electrode 130 may also be made of a reflective material. For example, the first electrode 130 may be made of lithium (Li), calcium (Ca), lithium fluoride/calcium (LiF/Ca), lithium fluoride/aluminum (LiF/Al), aluminum (Al), silver (Ag), magnesium (Mg), or gold (Au).

The first electrode 130 may also be made of a transparent or semi-transparent material. For example, the first electrode 130 may be made of indium tin oxide (ITO), indium zinc oxide (IZO), zinc oxide (ZnO), or indium oxide (In₂O₃). Also, the first electrode 130 may be made of Mg, Ag, Ca, Li, Al, or a combination of the same.

In a light-emitting layer, holes supplied from an anode electrode and electrons supplied from a cathode electrode may combine to form excitons. The light-emitting layer may emit light due to energy generated when the excitons return to a ground state.

The pixel defining film 132 may be disposed on the planarization film 124. The pixel defining film 132 may define respective regions of the pixels 105 and 110 included in the OLED display. The pixel defining film 132 may not cover the first electrode 130 or may cover part of the first electrode 130.

The organic layer 135 may be disposed on the first electrode 130. The organic layer 135 may emit light when an electric current flows through the organic layer 135. In the organic layer 135, holes and electrons supplied from the first electrode 130 and the second electrode 150 may combine together to form excitons. When an energy level of the excitons changes from an excited state to a ground state, the organic layer 135 may emit light of a color corresponding to the changed energy level. Depending on the embodiment, the color of light emitted from the organic layer 135 may be one of red, blue and green. The brightness of light emitted from the organic layer 135 may vary according to the size of an electric current that flows through the organic layer 135.

The OLED display according to the embodiments may include light-emitting regions R1 and R2 and a non-light-emitting region R3. The light-emitting regions R1 and R2 may be regions which perpendicularly overlap the organic layer 135. The non-light-emitting region R3 may be defined as a region excluding the light-emitting regions R1 and R2. The number of the light-emitting regions R1 and R2 may be equal to the number of the pixels 105 and 110.

The second electrode 150 may be disposed on the organic layer 135. The second electrode 150 may be made of, but not limited to, the same material as the first electrode 130. The light emission of the organic layer 135 may be controlled by an electric current that flows between the first electrode 130 and the second electrode 150. The second electrode 150 may serve as a common electrode in the OLED display.

Referring to FIG. 1, in the first embodiment, the second electrode 150 may cover substantially the entire top surface of the pixel defining film 132 and substantially the entire top surface of the organic layer 135. That is, the second electrode 150 may overlap all of the light-emitting regions R1 and R2 and the non-light-emitting region R3 included in the OLED display.

The number of portions of the second electrode 150 which respectively overlap the light-emitting regions R1 and R2 may be equal to the number of the light-emitting regions R1 and R2. At least two of the portions of the second electrode 150 which respectively overlap the light-emitting regions R1 and R2 may have different thicknesses.

To make the second electrode 150 have different thicknesses at different locations, the OLED display may be manufactured as follows. In a first stacking operation, the second electrode 150 may be stacked to a predetermined thickness to cover substantially the entire top surface of the pixel defining film 132 and substantially the entire top surface of the organic layer 135. Then, in a second stacking operation, all portions of the second electrode 150 are masked, excluding portions whose thicknesses are to be increased, and the second electrode 150 is additionally stacked on the unmasked portions. Depending on the embodiment, the process of additionally stacking the second electrode 150 may be repeated in a similar way to the second stacking operation.

For example, referring to FIG. 1, the OLED display according to the first embodiment may include the first light-emitting region R1 and the second light-emitting region R2. The first light-emitting region R1 may correspond to the first pixel 105, and the second light-emitting region R2 may correspond to the second pixel 110. A portion of the second electrode 150 which overlaps the second light-emitting region R2 may be thinner than a portion of the second electrode 150 which overlaps the first light-emitting region R1. For example, a ratio of a thickness of the portion of the second electrode 150 which overlaps the first light-emitting region R1 to a thickness of the portion of the second electrode 150 which overlaps the second light-emitting region R2 may be 10:7.

Due to such a difference in the thickness of the second electrode 150, the intensity of an electric current flowing through the organic layer 135 included in the second pixel 110 may be weaker than that of an electric current flowing through the organic layer 135 included in the first pixel 105. In other words, the luminance of light emitted from a pixel corresponding to a relatively thin portion of the second electrode 150 may be lower than that of light emitted from a pixel corresponding to a relatively thick portion of the second electrode 150.

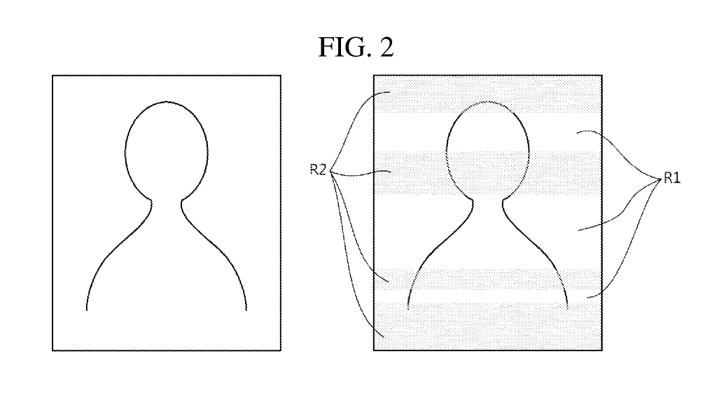

FIG. 2 is a diagram illustrating the effect of the first embodiment. An original image is shown on the left side of FIG. 2. On the right side of FIG. 2 is shown an image obtained by scanning the OLED display according to the first embodiment, which is displaying the original image, using a scanner.

Portions of the second electrode 150 which overlap light-emitting regions corresponding to R2 regions on the right side of FIG. 2 may be thinner than portions of the second electrode 150 which overlap light-emitting regions corresponding to R1 regions.

A manufacturer of the OLED display according to the first embodiment may form the second electrode 150 such that the second electrode 150 has different thicknesses at the locations of the light-emitting regions R1 and R2. Accordingly, a displayed image may have a different luminance at each location in the displayed image.

The distribution of luminances at different locations on the OLED display can be detected by comparing the original image on the left side of FIG. 2 with the scanned image on the right side of FIG. 2. That is, a difference value between data of the original image and data of the scanned image may be calculated. Using the calculated difference value, regions having relatively higher luminances than corresponding regions of the original image and regions having relatively lower luminances than corresponding regions of the original image can be detected in the scanned image.

If an OLED display manufacturer manufactures each OLED display to have a different luminance distribution, the luminance distribution can be used as unique identification information for identifying the OLED display. That is, a permutation or combination of detected luminance values can be used as identification information for identifying the OLED display.

For example, luminance at each location may be adjusted to produce a striped pattern as shown on the right side of FIG. 2. The striped pattern may be, e.g., a barcode. The barcode may be read by comparing the scanned image of the OLED display and the original image. Using the read barcode, an authentication procedure may be performed. In FIG. 2, a pattern corresponding to the barcode is shown as an example. However, any type of pattern can be used as long as it corresponds to identification information or information that can be converted into the identification information. For example, luminance at each location may be adjusted to produce a pattern corresponding to a quick response (QR) code.

For example, the OLED display according to the first embodiment may be included in a passport or an identification card. In this case, unique identification information may be read from the OLED display, and whether the passport or the identification card has been forged or falsified can be determined based on the read identification information.

In the OLED display, the difference between a region with a relatively higher luminance and a region with a relatively lower luminance cannot be easily distinguished with the naked eye. However, the difference in luminance may be adjusted to be large enough to be detected by the scanner and an image processor which compares a scanned image with an original image.

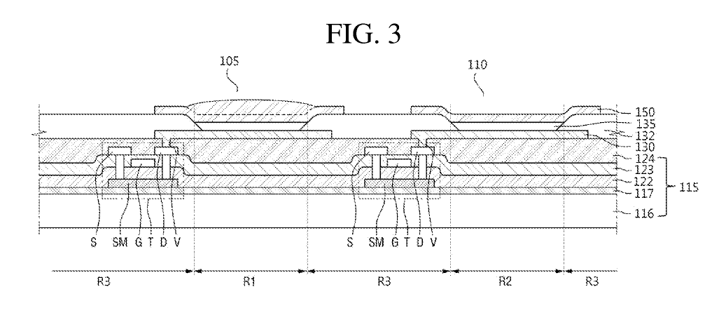

FIG. 3 is a longitudinal sectional view of an OLED display according to a second embodiment.

Referring to FIG. 3, unlike in the first embodiment, in the second embodiment, a second electrode 150 may be separated into a plurality of portions respectively corresponding to a plurality of pixels 105 and 110. The second electrode 150 may overlap light-emitting regions R1 and R2 included in the OLED display and may not overlap a non-light-emitting region R3. Therefore, the number of the portions of the second electrode 150 included in the OLED display may be equal to the number of the light-emitting regions R1 and R2 included in the OLED display.

As in the first embodiment, in the second embodiment, at least two or more of the portions of the second electrode 150 may have different thicknesses. Accordingly, the second electrode 150 may have a different thickness at each location on the OLED display. In addition, an image displayed on the OLED display may have a different luminance at each location in the image. Other features of the second embodiment are identical to those of the first embodiment, and thus a detailed description thereof is omitted.

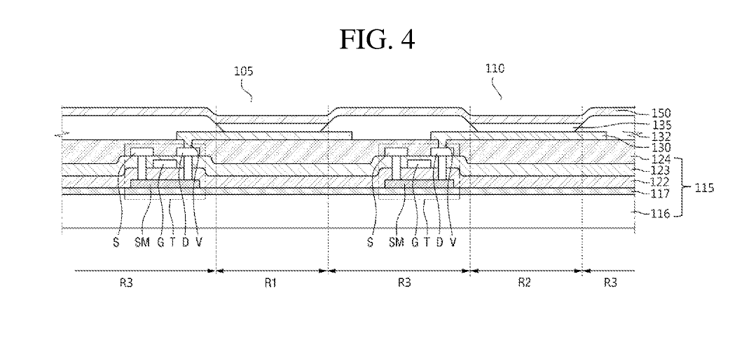

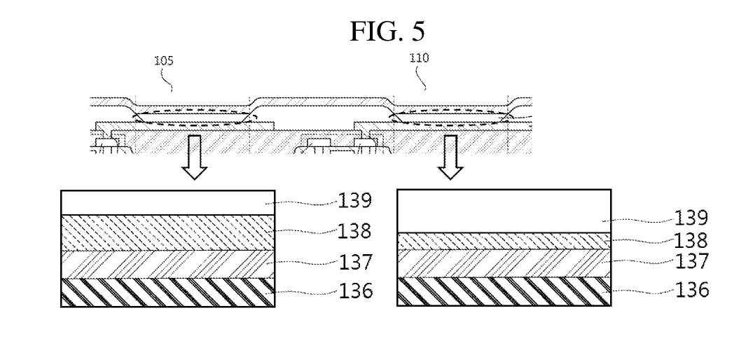

FIG. 4 is a longitudinal sectional view of an OLED display according to a third embodiment. FIG. 5 is an enlarged longitudinal sectional view of the OLED display according to the third embodiment.

Referring to FIG. 4, unlike in the OLED display according to the first or second embodiment, in the OLED display according to the third embodiment, a second electrode 150 may have a uniform thickness.

Referring to FIG. 5, an organic layer 135 included in each pixel 105 or 110 of the OLED display according to the third embodiment may include a hole injecting layer 136, a hole transporting layer 137 disposed on the hole injecting layer 136, a light-emitting layer 138 disposed on the hole transporting layer 137, and an electron transporting layer 139 disposed on the light-emitting layer 138. Therefore, the number of the light-emitting layers 138 included in the OLED display may be equal to the number of light-emitting regions R1 and R2 included in the OLED display.

In the light-emitting layer 138, holes supplied from the hole transporting layer 137 and electrons supplied from the electron transporting layer 139 may combine to form excitons. The light-emitting layer 138 may emit light due to energy generated when the excitons return to a ground state.

In the OLED display according to the third embodiment, the light-emitting layers 138 included in at least two or more of the pixels 105 and 110 may have different thicknesses. Light emitted from the light-emitting layers 138 having different thicknesses may have different luminances. In addition, the light emitted from the light-emitting layers 138 having different thicknesses may have different resonance effects. Accordingly, the emitted light may have different luminances.

As described above, the color of light emitted from the organic layer 135 may be any one of red, blue, and green. Therefore, if the thickness of the light-emitting layer 138 varies according to location on the OLED display, chromaticity coordinates of emitted light may vary according to location on the OLED display.

Therefore, in a state where the OLED display is displaying an original image, the OLED display may be scanned using a scanner. Then, identification information included in the OLED display may be read by comparing the scanned image and the original image. Other features of the third embodiment are identical to those of the first embodiment, and thus a detailed description thereof is omitted.

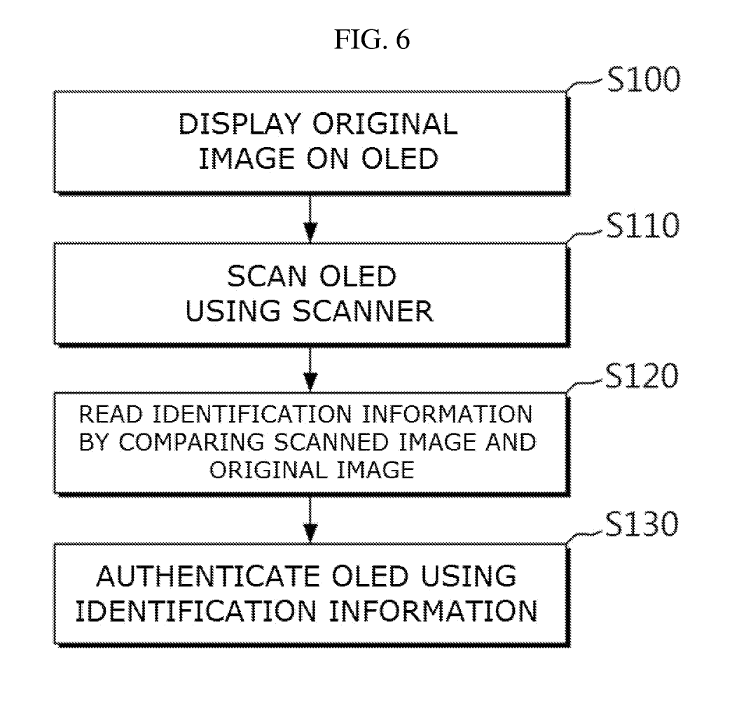

FIG. 6 is a flowchart illustrating a process of authenticating an OLED display according to an embodiment.

Referring to FIG. 6, an original image is displayed on an OLED display according to an embodiment (operation S100). The OLED display which is displaying the original image is scanned using a scanner (operation 5110). Then, identification information included in the OLED display is read by comparing the scanned image and the original image (operation S120). Finally, the OLED display is authenticated using the read identification information (operation S130).

As described above, an OLED display according to an embodiment may include identification information. According to an embodiment, authentication can be performed using the OLED display. In addition, an authentication method according to an embodiment can prevent the forging or falsification of the identification information.

While the disclosed embodiments have been described with reference to the accompanying drawings, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. An organic light-emitting diode (OLED) display comprising:
a plurality of pixels, wherein at least two of the pixels are configured such that a value, into which a permutation or combination of luminance values of light emitted respectively from the at least two pixels is converted based at least partially on data of an original image displayed on the OLED display, is used as identification information configured to identify the OLED display.

2. The display of claim 1, wherein each of the pixels comprises:
a thin-film transistor (TFT);
a first electrode disposed over the TFT; and
an organic layer disposed over the first electrode,
wherein the OLED display further comprises a second electrode disposed over the pixels, and wherein the second electrode comprises at least two portions which overlap the pixels and have different thicknesses from each other.

3. The display of claim 2, wherein each of the pixels further comprises a pixel defining film, wherein the pixel defining film is disposed over the TFT and does not cover the first electrode or covers part of the first electrode, and wherein the second electrode is disposed over the pixel defining film and the pixels.

4. The display of claim 1, wherein each of the pixels comprises:
a thin-film transistor (TFT);
a first electrode disposed over the TFT;
an organic layer disposed over the first electrode; and
a second electrode disposed over the organic layer,
wherein the second electrodes included in at least two of the pixels have different thicknesses from each other.

5. The display of claim 1, wherein the identification information comprises at least one of a barcode and a quick response (QR) code.

6. An organic light-emitting diode (OLED) display comprising:
a first region comprising at least one pixel; and
a second region comprising at least one pixel which is configured to emit light having a lower luminance than that of light emitted from the at least one pixel of the first region,
wherein the first region and the second region are configured such that a value, into which luminance values of light emitted from the first and second regions are converted based at least partially on data of an original image displayed on the OLED display and regardless of a type of the original image, is used as identification information configured to identify the OLED display.

7. The display of claim 6, wherein each of the at least one pixel included in the first region and the at least one pixel included in the second region comprises:
a thin-film transistor (TFT);
a first electrode disposed over the TFT;
an organic layer disposed over the first electrode; and
a second electrode disposed over the organic layer,
wherein the thickness of the second electrode included in the at least one pixel of the first region is different from the thickness of the second electrode included in the at least one pixel of the second region.

8. The display of claim 6, wherein the identification information comprises at least one of a barcode and a quick response (QR) code.

9. An organic light-emitting diode (OLED) display comprising a plurality of pixels, wherein each of the pixels comprises:
a thin-film transistor (TFT);
a first electrode disposed over the TFT;
an organic layer disposed over the first electrode; and
a second electrode disposed over the organic layer,
wherein the second electrodes included in at least two of the pixels are disposed such that a permutation or combination of thickness values of the second electrodes included in the at least two pixels is used as identification information configured to identify the OLED display.

10. An organic light-emitting diode (OLED) display comprising a plurality of pixels, wherein each of the pixels comprises:
a thin-film transistor (TFT);
a first electrode disposed over the TFT;
a hole injecting layer disposed over the first electrode;
a hole transporting layer disposed over the hole injecting layer;
a light-emitting layer disposed over the hole transporting layer;
an electron transporting layer disposed over the light-emitting layer; and
a second electrode disposed over the electron transporting layer,
wherein the light-emitting layers included in at least two of the pixels are disposed such that a permutation or combination of thickness values of the light-emitting layers included in the at least two pixels is used as identification information configured to identify the OLED display.

11. An organic light-emitting diode (OLED) display comprising:
a plurality of pixels, wherein at least two of the pixels are configured such that a value, into which a permutation or combination of chromaticity values of light emitted respectively from the at least two pixels is converted based at least partially on data of an original image displayed on the OLED display, is used as identification information configured to identify the OLED display.

12. A method of authenticating an organic light-emitting diode (OLED) display, the method comprising:
displaying an original image on the OLED display which comprises a plurality of pixels;
scanning the OLED display, which is displaying the original image, with the use of a scanner;
reading identification information for identifying the OLED display based on comparison of the scanned image and the original image; and
authenticating the OLED display based at least partially on the read identification information.

13. The method of claim 12, wherein the identification information is read based at least partially on a permutation or combination of luminance values of light emitted respectively from at least two of the pixels.

14. The method of claim 12, wherein the identification information is read based at least partially on a permutation or combination of chromaticity values of light emitted respectively from at least two of the pixels.

15. The method of claim 12, wherein the identification information comprises at least one of a barcode and a quick response (QR) code.

16. An identification card comprising:
an organic light-emitting diode (OLED) display which comprises a plurality of pixels, wherein at least two of the pixels are configured such that a value, into which a permutation or combination of luminance values of light emitted respectively from the at least two pixels is converted based at least partially on data of an original image displayed on the OLED display, is used as identification information configured to identify the OLED display.

17. The identification card of claim 16, wherein each of the pixels comprises:
a thin-film transistor (TFT);
a first electrode disposed over the TFT; and
an organic layer disposed over the first electrode,
wherein the OLED display further comprises a second electrode disposed over the pixels, and wherein the second electrode comprises at least two portions which overlap the pixels and have different thicknesses from each other.

18. The identification card of claim 17, wherein each of the pixels further comprises a pixel defining film, wherein the pixel defining film is disposed over the TFT and does not cover the first electrode or covers part of the first electrode, and wherein the second electrode is disposed over the pixel defining film and the pixels.

19. The identification card of claim 16, wherein each of the pixels comprises:
a thin-film transistor (TFT);
a first electrode disposed over the TFT;
an organic layer disposed over the first electrode; and
a second electrode disposed over the organic layer,
wherein the second electrodes included in at least two of the pixels have different thicknesses from each other.

20. The identification card of claim 16, wherein the identification information comprises at least one of a barcode or a quick response (QR) code.
